(19) United States
(12) Patent Application Publication
(10) Pub. No.: US 2026/0088564 A1
(43) Pub. Date: Mar. 26, 2026

(54) CONNECTOR

(71) Applicant: SUMITOMO WIRING SYSTEMS, LTD., Mie (JP)

(72) Inventors: Akihisa OGAWA, Mie (JP); Hiroki OKANO, Mie (JP)

(21) Appl. No.: 19/328,615

(22) Filed: Sep. 15, 2025

(30) Foreign Application Priority Data
Sep. 20, 2024 (JP) 2024-164018

(51) Int. Cl. H01R 13/629; H01R 13/02; H01R 13/10; H01R 13/508

(52) U.S. Cl. CPC H01R 13/62938; H01R 13/025; H01R 13/10; H01R 13/508; H01R 13/62955

(57) ABSTRACT

A moving plate includes a plate body whose plate surfaces face a front-rear direction within a hood portion, front protruded portions protruding from the front surface of the plate body, and through holes extending through the plate body and the respective front protruded portions. The plate body is movable rearward, that is, in a direction approaching a male mating surface, from an initial position to a fitting position within the hood portion. A female housing includes opening peripheral surface portions expanding toward the front protruded portions, at opening edge portions of female cavities in a female mating surface, respectively. Each front protruded portion has a shape surrounding the entire periphery of the through hole on the front surface side of the plate body.

### CROSS-REFERENCE TO RELATED APPLICATIONS

This application is based on and claims priority from Japanese Patent Application No. 2024-164018, filed on Sep. 20, 2024, with the Japan Patent Office, the disclosure of which is incorporated herein in its entirety by reference.

### TECHNICAL FIELD

The present disclosure relates to a connector.

### BACKGROUND

A connector disclosed in JP 2017-188244 A includes a first housing and a second housing capable of mating with each other, and a moving plate that is attached to the first housing. The first housing has a tubular hood portion that is open to the front. The moving plate is held at an initial position in the hood portion. The second housing is fitted into the hood portion. In a mating process of the first housing and the second housing, the moving plate moves rearward from the initial position. The moving plate has a plate body. The plate body is disposed with the plate surfaces thereof facing the front-rear direction. A plurality of through holes are formed to extend through the plate body in the front-rear direction.

The first housing holds male terminal fittings. The male terminal fittings respectively include tab portions. When the moving plate is at the initial position, leading end portions of the tab portions are respectively inserted into the through holes. The tab portions are protected from extraneous materials by the moving plate. Note that a connector provided with a moving plate is also disclosed in JP 2006-196225 A and JP 2002-015811 A.

### SUMMARY

In the above description, if the length in the front-rear direction of the through holes increases, the state of insertion of the tab portions into the through holes is stabilized, and it is possible to make it unlikely for the tab portions to deform. However, there is a problem in that, if an increase in the length in the front-rear direction of the through holes results in a change in the shape of the second housing, which is a mating partner that comes into contact with the plate body, the mold for forming the second housing also needs to be changed, leading to an increase in the cost.

In view of this, an object of the present disclosure is to provide a connector that enables tab portions to be unlikely to deform, and does not require a mold to be changed.

A connector according to the present disclosure is a connector including: a female connector and a male connector capable of mating with each other, wherein the female connector includes: a female housing including a female cavity and a female mating surface; and a female terminal fitting that is housed in the female cavity, the male connector includes a male housing including a male mating surface, a male terminal fitting that is held in the male housing, and a moving plate that is disposed movably in a front-rear direction relative to the male housing, the male housing includes a tubular hood portion that is open to the front, the male mating surface is a back surface of the hood portion, the moving plate includes a plate body whose plate surfaces face the front-rear direction within the hood portion, a front protruded portion that protrudes from a front surface that faces the female mating surface, out of the plate surfaces of the plate body, and a through hole extending through the plate body and the front protruded portion, the plate body moves rearward, that is, in a direction approaching the male mating surface, from an initial position to a fitting position within the hood portion in a mating process of the female connector and the male connector, and is sandwiched between the female mating surface and the male mating surface when mating is complete, the male terminal fitting includes a tab portion that is inserted into the through hole, and is connected to the female terminal fitting when the mating is complete, the female housing includes opening peripheral surface portions expanding toward the front protruded portion, at an opening edge portion of the female cavity in the female mating surface, the front protruded portion has a shape surrounding an entire periphery of the through hole, on a front surface side of the plate body, and an outer surface of the front protruded portion includes inclined surface portions that taper toward the front and are disposed along the respective opening peripheral surface portions when the mating is complete.

According to the present disclosure, it is possible to provide a connector that enables tab portions to be unlikely to deform, and does not require a mold to be changed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a male connector in a connector according to a first embodiment.

FIG. 2 is an exploded perspective view of a female connector in the connector according to the first embodiment.

FIG. 3 is a front view of the female connector in the connector according to the first embodiment.

FIG. 4 is a front view of the male connector in the connector according to the first embodiment.

FIG. 5 is a front view of a male frame in the connector according to the first embodiment.

FIG. 6 is a perspective view of a moving plate in the connector according to the first embodiment.

FIG. 7 is a front view of the moving plate in the connector according to the first embodiment.

FIG. 8 is a rear view of the moving plate in the connector according to the first embodiment.

FIG. 9 is a cross-sectional side view showing a state where the moving plate is at an initial position and the female connector is shallowly fitted into a hood portion, in the connector according to the first embodiment.

FIG. 10 is a cross-sectional side view showing a state where the moving plate is at a fitting position and the female connector is fitted into the hood portion at a proper depth, in the connector according to the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.
(1) A connector according to the present disclosure including: a female connector and a male connector capable of mating with each other, wherein the female connector includes: a female housing including a female cavity and a female mating surface; and a female terminal fitting that is housed in the female cavity, the male connector includes a male housing including a male mating surface, a male terminal fitting that is held in the male housing, and a moving plate that is disposed movably in a front-rear direction relative to the male housing, the male housing includes a tubular hood portion that is open to the front, the male mating surface is a back surface of the hood portion, the moving plate includes a plate body whose plate surfaces face the front-rear direction within the hood portion, a front protruded portion that protrudes from a front surface that faces the female mating surface, out of the plate surfaces of the plate body, and a through hole extending through the plate body and the front protruded portion, the plate body moves rearward, that is, in a direction approaching the male mating surface, from an initial position to a fitting position within the hood portion in a mating process of the female connector and the male connector, and is sandwiched between the female mating surface and the male mating surface when mating is complete, the male terminal fitting includes a tab portion that is inserted into the through hole, and is connected to the female terminal fitting when the mating is complete, the female housing includes opening peripheral surface portions expanding toward the front protruded portion, at an opening edge portion of the female cavity in the female mating surface, the front protruded portion has a shape surrounding an entire periphery of the through hole, on a front surface side of the plate body, and an outer surface of the front protruded portion includes inclined surface portions that taper toward the front and are disposed along the respective opening peripheral surface portions when the mating is complete.

With the configuration in the above (1), by inserting the tab portion into the through hole, the tab portion is protected not only by the plate body but also by the front protruded portion, and thus it is possible to make it unlikely for the tab portion to deform. When mating of the female connector and the male connector is complete (when the female connector and the male connector are mated to each other at a predetermined fitting depth), the inclined surface portions of the front protruded portion are disposed along the opening peripheral surface portions of the female housing. The opening peripheral surface portions of the female housing are an existing configuration provided in the female housing as a guide for guiding the tab portion into the female cavity. Thus, the shape of the female housing does not need to be changed in accordance with the shape of the moving plate, and a mold for forming the female housing also does not need to be changed.
(2) In the connector according to the above (1), it is preferable that the through hole includes a straight hole portion extending in the front-rear direction from the front protruded portion to the plate body.

With the configuration in the above (2), the insertion state of the tab portion can be stabilized due to the straight hole portion, and it is possible to make it further unlikely for the tab portion to deform.
(3) In the connector according to the above (2), it is preferable that the female cavity includes a tab insertion hole extending in the front-rear direction and facing the opening peripheral surface portions, and the tab insertion hole and the through hole are aligned in the front-rear direction such that there is no difference in level between inner surfaces of the tab insertion hole and the through hole when the mating is complete.

With the configuration in the above (3), when the mating of the female connector and the male connector is complete, it is possible to maintain a state where the tab portion is disposed linearly in the front-rear direction in a region extending from the through hole to the tab insertion hole. For this reason, the insertion state of the tab portion can be further stabilized.
(4) In the connector according to any one of the above (1) to (3), it is preferable that the plate body has a shape that is longer in a left-right direction than in an up-down direction, a plurality of the through holes are aligned vertically and laterally in front view and rear view of the plate body, and front protruded portions are provided in correspondence with at least through holes aligned in the left-right direction in a vertical intermediate portion of the plate body, from among the plurality of through holes.

With the configuration in the above (4), the vertical intermediate portion of the plate body is made thick due to the front protruded portions. For this reason, it is possible to avoid a situation where a lateral intermediate portion of the plate body is warped and deformed in a high-temperature environment or the like.
(5) In the connector according to any one of the above (1) to (4), it is preferable that the moving plate includes rear peripheral surface portions expanding toward a rear surface of the plate body, at a rear end opening edge portion of the through hole, and the inclined surface portions of the front protruded portion and the respective rear peripheral surface portions are set to be parallel to each other.

With the configuration in the above (5), the thickness formed between the inclined surface portions of the front protruded portion and the respective rear peripheral surface portions of the plate body can be made uniform in the direction of inclination of the inclined surface portions, thus providing excellent moldability and making it possible to prevent an excessive stress from being generated in the inclined surface portions and the rear peripheral surface portions.

### DETAILS OF EMBODIMENTS OF THE PRESENT DISCLOSURE

Specific examples of the present disclosure will be described below with reference to the drawings. Note that the present invention is not limited to these examples, but rather is indicated by the claims, and is intended to include all modifications that are within the meanings and the scope that are equivalent to those of the claims.

### First Embodiment

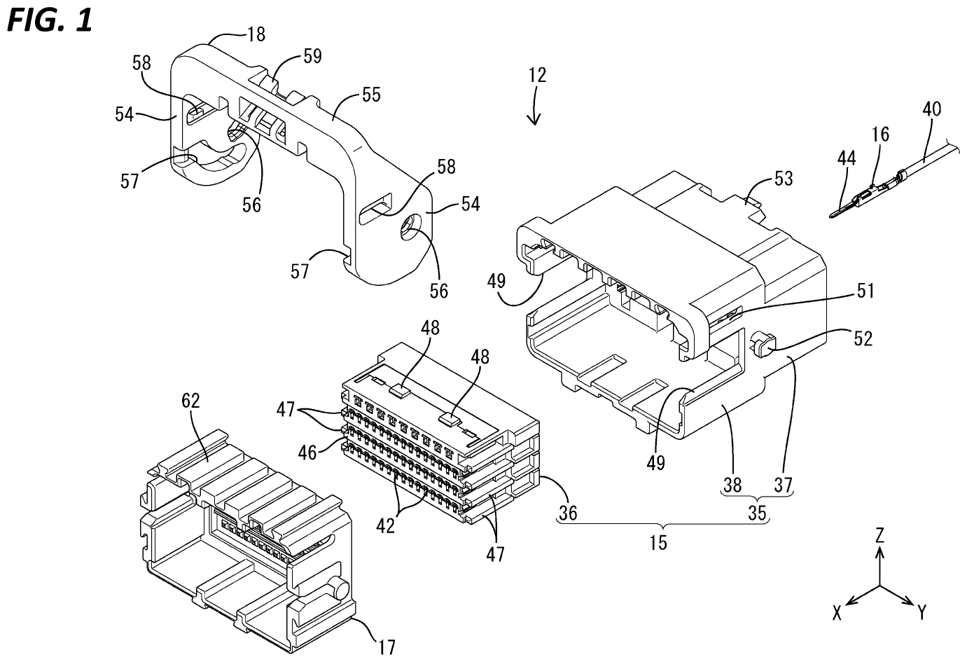

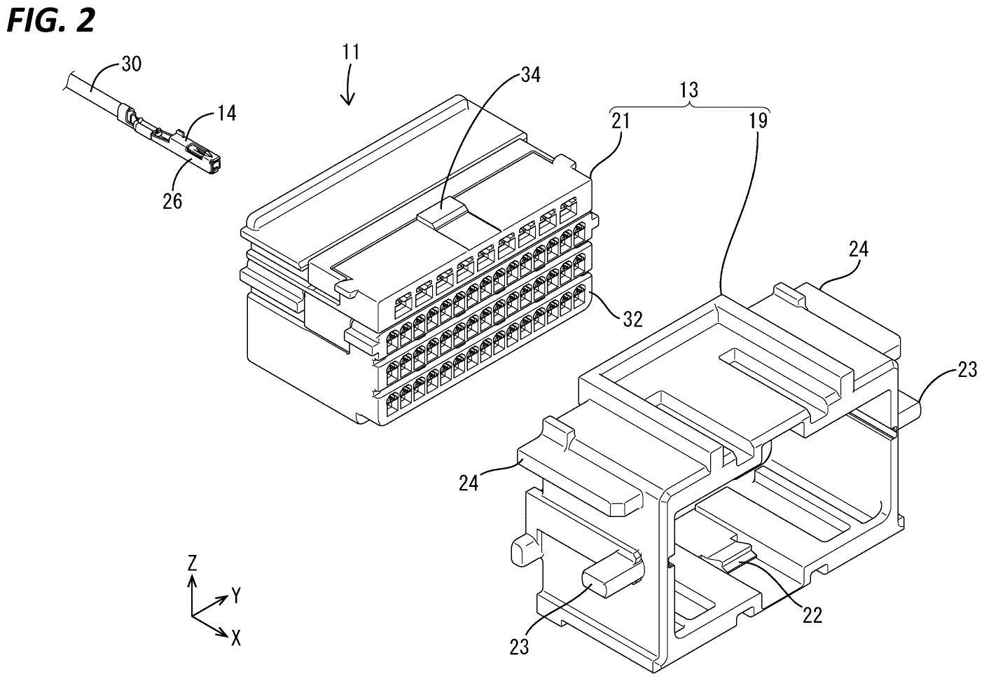

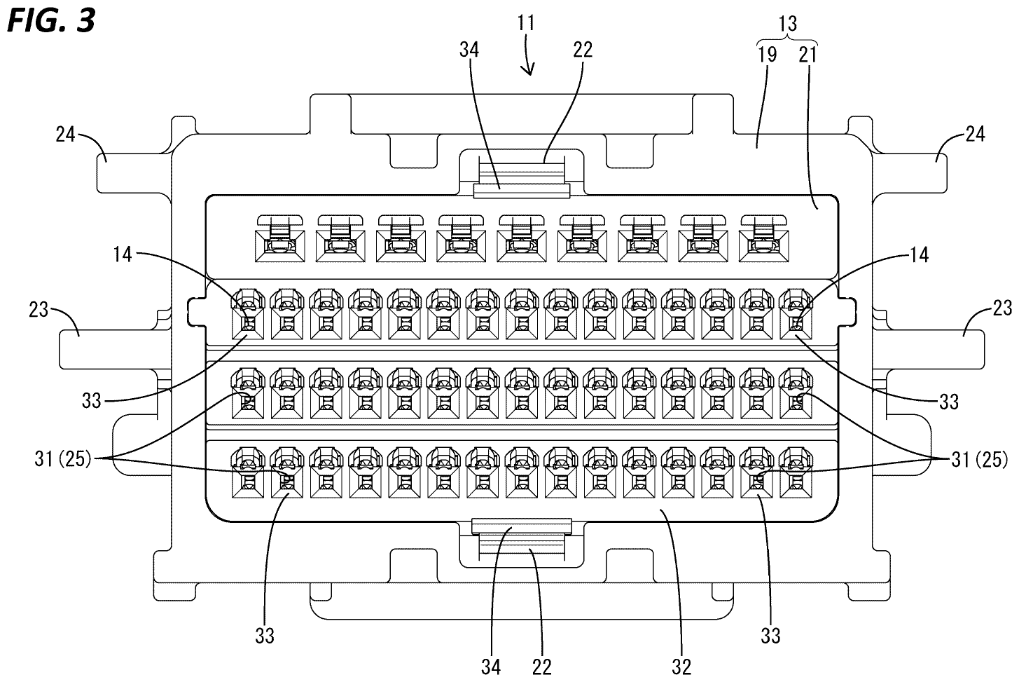

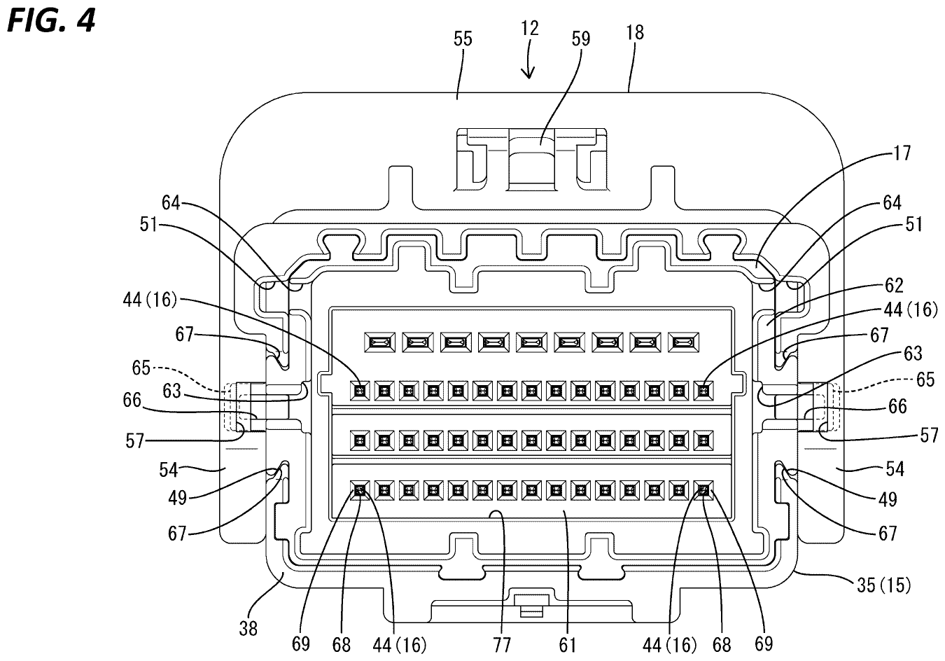

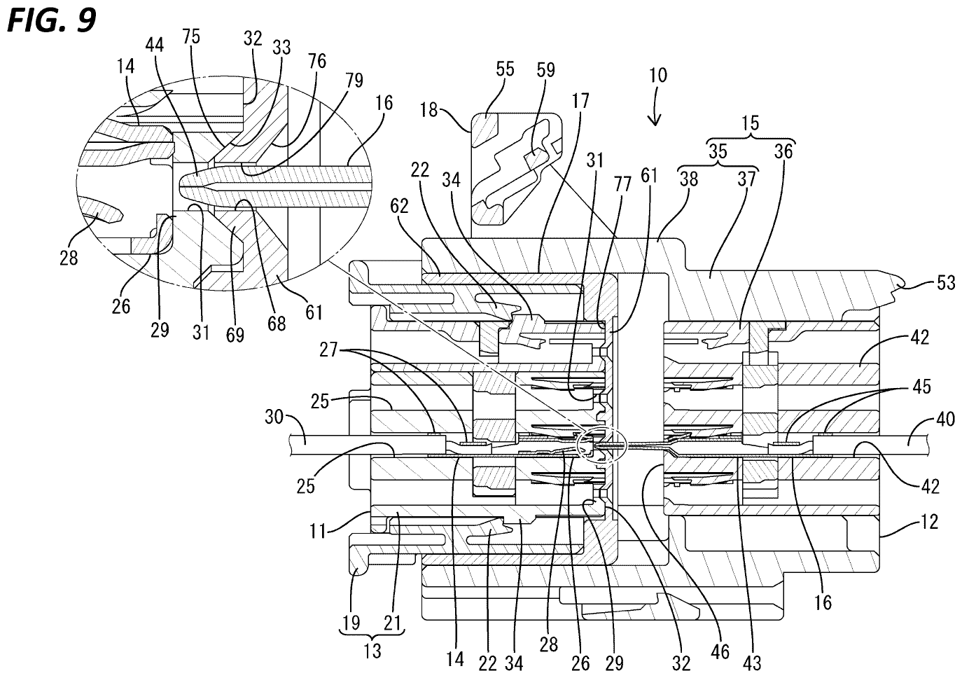

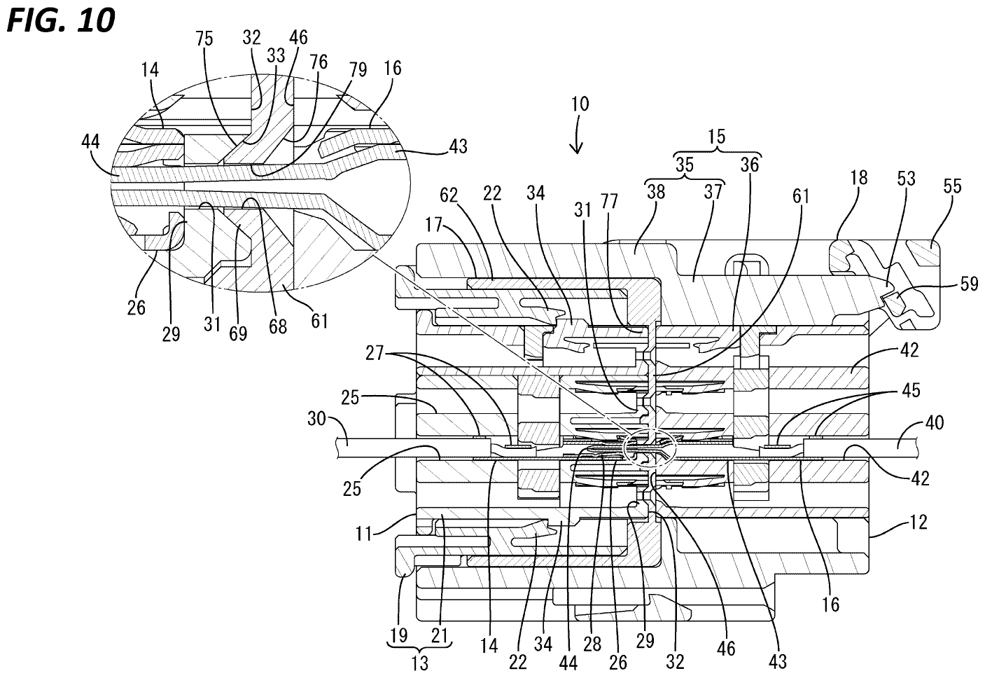

As shown in FIGS. 9 and 10, a connector 10 according to a first embodiment of the present disclosure includes a female connector 11 and a male connector 12 capable of mating with each other. As shown in FIGS. 2 and 3, the female connector 11 includes a female housing 13 and a plurality of female terminal fittings 14 (only one is shown in FIG. 2) that are housed in the female housing 13. As shown in FIGS. 1 and 4, the male connector 12 includes a male housing 15, a plurality of male terminal fittings 16 (only one is shown in FIG. 1) that are housed in the male housing 15, a moving plate 17 that is movably disposed in the male housing 15, and a lever 18 that is rotatably supported by the male housing 15. Note that, in the following description, in the front-rear direction, the direction in which the female connector 11 and the male connector 12 are mated with each other is defined as a forward direction. The up-down direction is based on the up-down direction in the figures, and the left-right direction is based on the left-right direction when viewed from the front. In FIGS. 1 and 2, the arrows X, Y, and Z indicate the forward, rightward, and upward directions, respectively. Such bases for directions are set for convenience and do not necessarily match a basis for a direction in a state where the connector 10 is mounted in a vehicle or the like (not shown).

### Female Housing 13 and Female Terminal Fittings 14

The female housing 13 is made of a synthetic resin. In the first embodiment, as shown in FIGS. 2 and 3, the female housing 13 is constituted by a female frame 19 and a female inner housing 21 that is housed in the female frame 19. The female frame 19 has the shape of a rectangular case that is longer in the left-right direction than in the up-down direction, and is open in the front-rear direction. As shown in FIG. 3, a pair of upper and lower female lock portions 22 are formed to respectively protrude from the upper and lower inner surfaces of the female frame 19. The female lock portions 22 are elastically deformable in the up-down direction. In addition, a pair of left and right housing-side cam pins 23 are formed to protrude from vertical intermediate portions of the left and right outer surfaces of the female frame 19. The housing-side cam pins 23 protrude, while extending in the front-rear direction in the shape of ribs, on the left and right outer surfaces of the female frame 19. The housing-side cam pins 23 can be inserted into cam grooves 57 of the lever 18 to be described later, in a state of being joined with plate-side cam pins 65 to be described later, respectively. A pair of left and right unlocking portions 24 are formed to protrude from upper end portions of the left and right outer surfaces of the female frame 19. The unlocking portions 24 unlock later-described initial lock portions 58 of the lever 18 and the male housing 15 from each other in a mating process of the female connector 11 and the male connector 12.

The female inner housing 21 is formed in a rectangular block shape, and has a plurality of female cavities 25 extending in the front-rear direction as shown in FIGS. 9 and 10. The female terminal fittings 14 are inserted into and housed in the corresponding female cavities 25 from the rear of the female inner housing 21.

Each of the female terminal fittings 14 is made of a conductive metal, and, as shown in FIGS. 9 and 10, includes a tubular connection portion 26 that is elongated in the front-rear direction, and a female barrel portion 27 that is continuous with the rear of the connection portion 26. As shown in FIG. 10, the connection portion 26 is electrically connected to a male terminal fitting 16 by bringing an elastic contact piece 28, which is disposed inside the connection portion 26, into contact with a tab portion 44 of the male terminal fitting 16 to be described later. The female barrel portion 27 is electrically and mechanically connected to a terminal portion of an electric wire 30 by being crimped thereto.

As shown in FIGS. 9 and 10, the female inner housing 21 has a front wall 29 for stopping the female terminal fittings 14 on the front side. The front wall 29 has a plurality of tab insertion holes 31 extending therethrough in the front-rear direction. The tab insertion holes 31 respectively correspond to the front end portions of the female cavities 25. The front surface of the front wall 29 of the female inner housing 21 serves as a female mating surface 32. The female mating surface 32 faces the front surface of a plate body 61 of the moving plate 17, which will be described later, in a contactable manner when the female connector 11 and the male connector 12 are mated with each other. As shown in FIG. 3, the tab insertion holes 31 of the respective female cavities 25 are open in the female mating surface 32, in multiple levels in the up-down direction and multiple rows in the left-right direction. As shown in FIGS. 9 and 10, the female mating surface 32 of the female inner housing 21 includes a plurality of opening peripheral surface portions 33 in the opening edge portions of the tab insertion holes 31 of the female cavities 25. On upper, lower, left, and right edge portions (the four side portions, namely, the entire peripheral portion) that are opening edge portions of each of the female cavities 25, opening peripheral surface portions 33 are formed as inclined surfaces each having a tapered shape, expanding toward the front where a front protruded portion 69 to be described later is positioned.

As shown in FIGS. 9 and 10, the female inner housing 21 includes a plurality of female lock receiving portions 34 that can be locked with the respective female lock portions 22. The female lock receiving portions 34 protrude from lateral intermediate portions of the upper and lower outer surfaces of the female inner housing 21. The female inner housing 21 is held in place inside the female frame 19 by locking the female lock receiving portions 34 with the respective female lock portions 22.

### Male Housing 15, Male Terminal Fittings 16, and Lever 18

The male housing 15 is made of a synthetic resin. In the first embodiment, as shown in FIGS. 1 and 4, the male housing 15 is constituted by a male frame 35 and a male inner housing 36 that is housed in the male frame 35. The male frame 35 has the overall shape of a rectangular case that is longer in the left-right direction than in the up-down direction and is open in the front-rear direction. The male frame 35 includes a frame body 37 and a hood portion 38 that protrudes forward from the frame body 37.

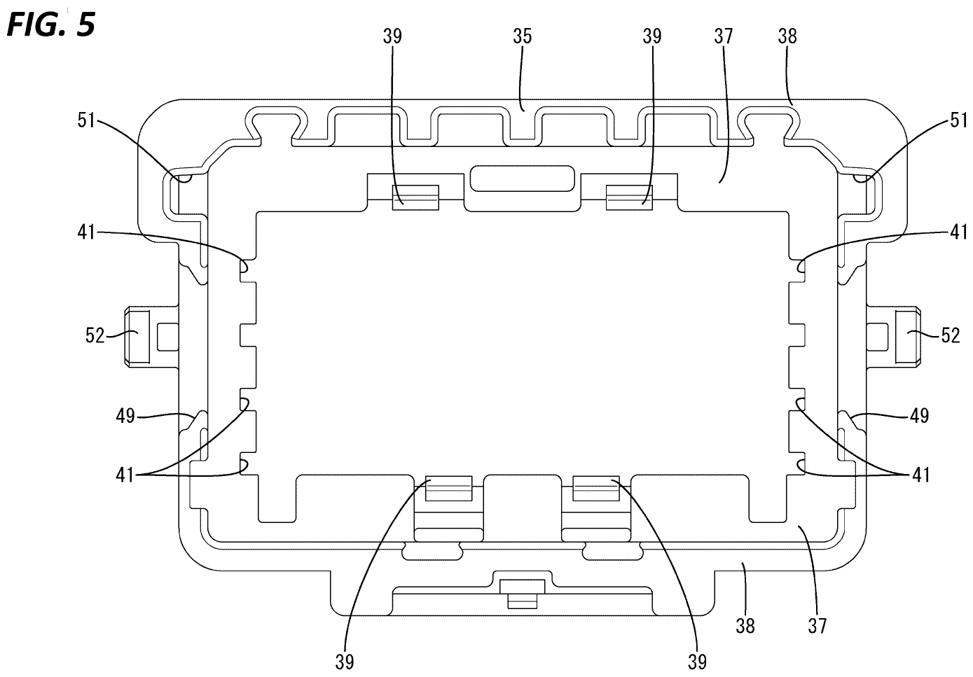

As shown in FIG. 5, the frame body 37 includes a pair of left and right male lock portions 39 on both the upper and lower sides, and a plurality of pairs of left and right male guide recessed portions 41 arranged in the up-down direction on the left and right sides. The male guide recessed portions 41 are recessed in the left and right inner surfaces of the frame body 37, and have a groove shape extending in the front-rear direction. The male lock portions 39 protrude from both the upper and lower inner surfaces of the male frame 35, spaced apart in the left-right direction. The male lock portions 39 are elastically deformable in the up-down direction.

The male inner housing 36 has the shape of a rectangular block, and has a plurality of male cavities 42. As shown in FIGS. 9 and 10, the male terminal fittings 16 are inserted into and housed in the corresponding male cavities 42 from the rear of the male inner housing 36. Each of the male terminal fittings 16 is made of a conductive metal, and includes a tubular male terminal body 43, the tab portion 44 that protrudes forward from the male terminal body 43, and a male barrel portion 45 continuous with and rearward of the male terminal body 43. The male barrel portion 45 is electrically and mechanically connected to a terminal portion of an electric wire 40 by being crimped thereto.

As shown in FIGS. 9 and 10, the front surface of the male inner housing 36 serves as a male mating surface 46. The male mating surface 46 of the male inner housing 36 corresponds to the back surface of the hood portion 38 and is disposed to face the front. As shown in FIG. 10, the male mating surface 46 of the male inner housing 36 faces the rear surface of the plate body 61 of the moving plate 17 in a contactable manner when mating of the female connector 11 and the male connector 12 is complete (when the connectors are properly mated at a predetermined fitting depth shown in FIG. 10). The male cavities 42 are open in the male mating surface 46, in multiple levels in the up-down direction and multiple rows in the left-right direction.

As shown in FIG. 1, the male inner housing 36 includes a plurality of male guide protruded portions 47. The male guide protruded portions 47 protrude from the left and right outer surfaces of the male inner housing 36, extending in the front-rear direction in a rib shape. When the male inner housing 36 is inserted into the frame body 37, the male guide protruded portions 47 are respectively mated with the male guide recessed portions 41. In addition, the male inner housing 36 has a plurality of male lock receiving portions 48 that can be locked by the respective male lock portions 39. The male lock receiving portions 48 protrude from lateral intermediate portions of both the upper and lower outer surfaces of the male inner housing 36 (only those formed on the upper outer surface are shown in FIG. 1), and are spaced apart from each other in the left-right direction. The male inner housing 36 is held inside the male frame 35 by mating the male guide protruded portions 47 with the respective male guide recessed portions 41 and locking the male lock portions 39 with the respective male lock receiving portions 48.

As shown in FIGS. 1 and 5, the male frame 35 includes a pair of left and right notch recessed portions 49 at vertical intermediate portions of the left and right walls of the hood portion 38. The notch recessed portions 49 extend in the front-rear direction and are open to the front of the hood portion 38. As shown in FIG. 4, left and right protruded portions of a peripheral wall portion 62 of the moving plate 17, which will be described later, are mated with the respective notch recessed portions 49. As shown in FIG. 5, the male frame 35 includes a pair of left and right locking recessed portions 51 at positions above the respective notch recessed portions 49 in the left and right side walls of the hood portion 38. The locking recessed portions 51 each have the shape of a slit extending in the front-rear direction (see FIG. 1) and are open to the front of the hood portion 38. The initial lock portions 58 of the lever 18 are locked with the inner surfaces of the respective locking recessed portions 51 (not illustrated).

As shown in FIGS. 1 and 5, the male frame 35 includes a pair of support shafts 52 protruding laterally outward from the rear ends of the left and right side walls of the hood portion 38. The support shafts 52 rotatably support the lever 18. As shown in FIG. 1, the male frame 35 has a lever lock portion 53 on the upper wall of the frame body 37. The lever lock portion 53 protrudes from a lateral intermediate portion of a rear end portion of the upper wall of the frame body 37. As shown in FIG. 10, the lever 18 can be locked with the lever lock portion 53 at a mating completion position to be described later.

The lever 18 is made of a synthetic resin, and, as shown in FIG. 1, has an overall gate-like shape. Specifically, the lever 18 includes a pair of left and right cam plate portions 54 and an operation portion 55 that extends in the left-right direction and is coupled to the cam plate portions 54. The lever 18 has a lock arm 59 at a lateral intermediate portion of the operation portion 55. The lever 18 is mounted to the male frame 35 in such a manner as to straddle it from above (see FIG. 4). The cam plate portions 54 have shaft holes 56 into which the support shafts 52 are fitted, respectively. Cam grooves 57 are provided in a recessed manner in the inner surfaces (surfaces facing each other) of the respective cam plate portions 54. In addition, the elastically deformable initial lock portions 58 are respectively formed in the cam plate portions 54.

The lever 18 is rotatable about the support shafts 52 relative to the male frame 35 between a mating start position (see FIG. 9) and the mating completion position (see FIG. 10), with the support shafts 52 being respectively fitted into the shaft holes 56. The lever 18 is held at the mating start position, on the male housing 15, by the initial lock portions 58 locking the inner surfaces of the locking recessed portions 51 of the male frame 35.

### Moving Plate 17

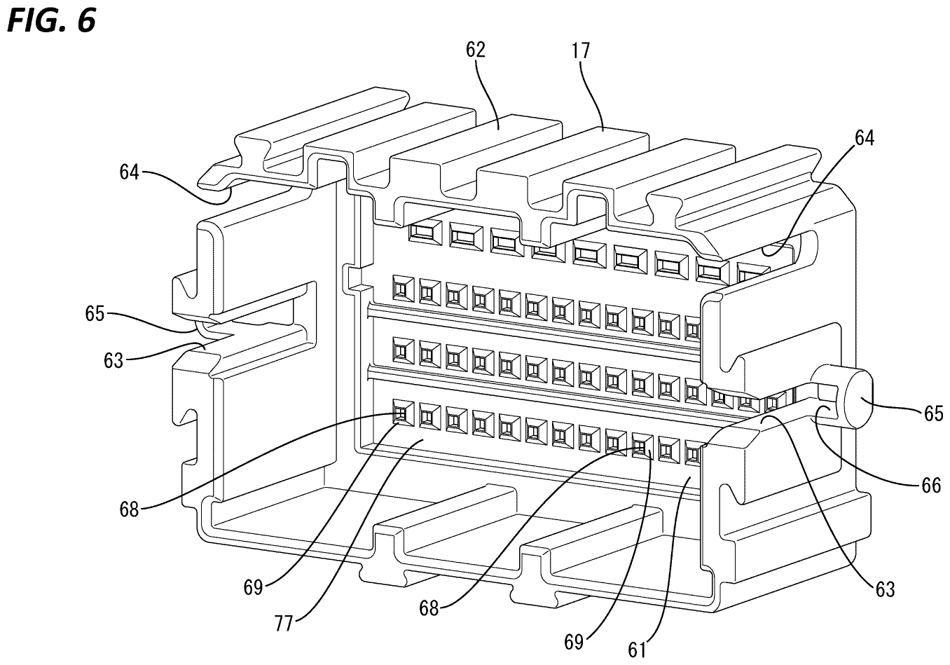

The moving plate 17 is made of a synthetic resin, and includes the flat plate body 61 whose plate surfaces face the front-rear direction, and the peripheral wall portion 62 having the shape of a rectangular tube and protruding forward from the plate body 61, as shown in FIGS. 6 to 8. As shown in FIG. 9, in a state where the moving plate 17 is disposed inside the hood portion 38, the plate body 61 is disposed forward of the male mating surface 46 of the male inner housing 36, and the peripheral wall portion 62 faces the inner peripheral surface of the hood portion 38 in a contactable manner.

The peripheral wall portion 62 has a pair of left and right introduction recessed portions 63 at vertical intermediate portions of the left and right side walls. The introduction recessed portions 63 extend in the front-rear direction and are open to the front of the peripheral wall portion 62. In the mating process of the female connector 11 and male connector 12, the housing-side cam pins 23 of the female housing 13 are respectively inserted into the introduction recessed portions 63. The peripheral wall portion 62 has a pair of left and right through recessed portions 64, at upper end portions of the left and right side walls. The through recessed portions 64 each have the shape of a slit extending in the front-rear direction, and are open to the front of the peripheral wall portion 62. As shown in FIG. 4, the through recessed portions 64 are in communication with the respective locking recessed portions 51 of the male frame 35 and are arranged in such a manner as to be able to receive the respective unlocking portions 24 of the female housing 13.

In addition, the peripheral wall portion 62 has a pair of left and right plate-side cam pins 65 rearward of the introduction recessed portions 63, in vertical intermediate portions of the outer surfaces of left and right side walls. The plate-side cam pins 65 have a gate-like shape, which is circular in side view. Receiving holes 66 are formed to extend through the respective plate-side cam pins 65 in the front-rear direction. As shown in FIG. 4, the receiving holes 66 of the plate-side cam pins 65 are disposed in communication with the respective introduction recessed portions 63. The housing-side cam pins 23 of the female housing 13 are mated with the receiving holes 66 through the introduction recessed portions 63, to be joined with the plate-side cam pins 65, respectively. As shown in FIGS. 6 to 8, vertical intermediate portions of both the left and right side walls of the peripheral wall portion 62 protrude laterally outward beyond the upper and lower end portions, and, on the upper and lower surfaces of each of the protruded portions, a pair of engagement end surfaces 67 extending in the front-rear direction and expanding vertically outward are formed. As shown in FIG. 4, the engagement end surfaces 67 face the upper and lower inner surfaces of the notch recessed portions 49 of the male frame 35 in a contactable manner.

As shown in FIGS. 6 to 8, the plate body 61 has a rectangular shape that is longer in the left-right direction than in the up-down direction in front view or rear view. A plurality of through holes 68 are formed to extend through the plate body 61 in the front-rear direction (the plate thickness direction). The tab portions 44 of the male terminal fittings 16 are respectively inserted into the through holes 68 from the rear (see FIG. 4). The through holes 68 are each shaped as an opening having a rectangular cross-section corresponding to the tab portion 44. In the plate body 61, the through holes 68 are arranged in multiple levels in the up-down direction and multiple rows in the left-right direction. The through holes 68 include straight hole portions 79 that linearly extend from later-described front protruded portions 69, respectively, to the plate body 61 in parallel with the male cavities 42.

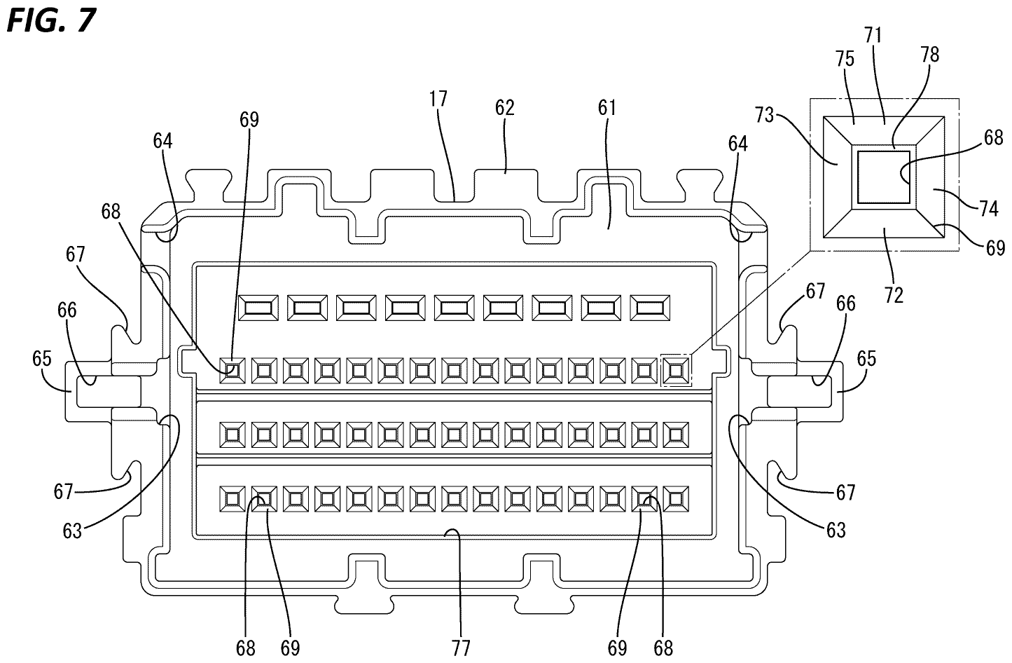

As shown in FIG. 7, a mating recessed portion 77 is provided in a recessed manner in an intermediate portion (excluding an outer peripheral region) of the front surface of the plate body 61. As shown in FIGS. 9 and 10, a front end portion of the female inner housing 21 including the female mating surface 32 is mated with and positioned by the mating recessed portion 77 of the plate body 61. The moving plate 17 has a plurality of front protruded portions 69 that protrude forward from the front surface of the plate body 61 (the back surface of the mating recessed portion 77). As shown in FIGS. 9 and 10, each straight hole portion 79 is formed in the front protruded portion 69 along the entire length thereof. In the first embodiment, the straight hole portion 79 is longer in the front protruded portion 69 than in the plate body 61. As shown in FIG. 7, the front protruded portions 69 are respectively formed for the corresponding through holes 68. Accordingly, adjacent front protruded portions 69 are spaced apart from each other. The front protruded portions 69 are provided in correspondence with all of the through holes 68 (including through holes 68 aligned in the left-right direction in a vertical intermediate portion).

Each of the front protruded portions 69 surrounds a front end portion of the through hole 68 (the straight hole portion 79) over the entire periphery thereof. As shown in FIG. 7, in front view, the front protruded portion 69 is made up of an upper side portion 71 and a lower side portion 72 that extend in the left-right direction, and a left side portion 73 and a right side portion 74 that extend in the up-down direction. Inclined surface portions 75 that taper toward the front are formed on the outer surfaces (peripheral surfaces) of the front protruded portion 69 as shown in FIGS. 9 and 10. The inclined surface portion 75 of the upper side portion 71 slopes downward toward the front. The inclined surface portion 75 of the lower side portion 72 slopes upward toward the front. The inclined surface portion 75 of the left side portion 73 slopes rightward toward the front. The inclined surface portion 75 of the right side portion 74 slopes leftward toward the front. The inclined surface portions 75 of the side portions 71 to 74 have the same inclination angle relative to the front-rear direction. The inclination angle of the inclined surface portions 75 relative to the front-rear direction is the same as or approximate to the inclination angle of the opening peripheral surface portions 33 relative to the front-rear direction. In the mating process of the female connector 11 and the male connector 12 and upon completion of mating, the inclined surface portions 75 of the front protruded portions 69 can be aligned with and face the opening peripheral surface portions 33 of the female housing 13, respectively, in a surface-contactable manner (including clearance). In addition, as shown in FIG. 7, a leading end surface portion 78 extending along the up-down direction and the left-right direction is formed at the front end of each front protruded portion 69. The leading end surface portion 78 is continuous with the front end of the inclined surface portions 75 and surrounds the outer periphery of the front end of the through hole 68, in a rectangular shape.

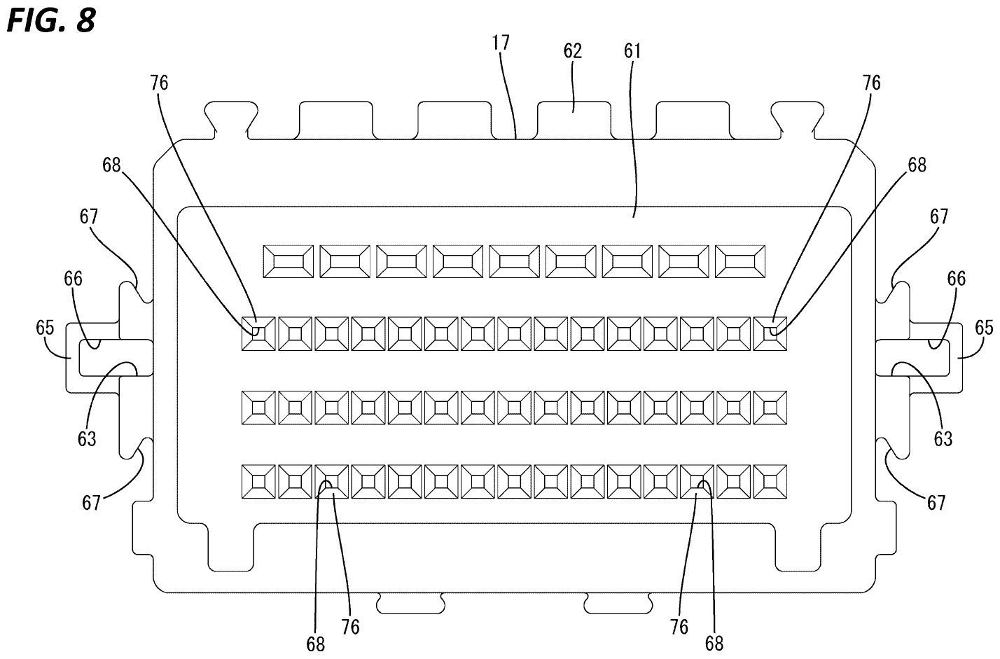

As shown in FIG. 8, the moving plate 17 has rear peripheral surface portions 76 on the rear end opening edge portions of the through holes 68, which are continuous with the straight hole portions 79. Similarly to the front protruded portions 69, the rear peripheral surface portions 76 are individually provided in correspondence with the through holes 68. On the rear end opening edge portions of the through holes 68, the rear peripheral surface portions 76 are formed as inclined surfaces each having a tapered shape, expanding toward the rear (the rear surface of the plate body 61). In the first embodiment, the rear peripheral surface portions 76 are respectively formed on the upper, lower, left, and right edge portions of each through hole 68 (the four side portions that make up the rear end opening edge portion) to cover the entire periphery of the through hole 68. As shown in FIG. 9 and FIG. 10, the inclination angles of the rear peripheral surface portions 76 relative to the front-rear direction are the same as or approximate to the inclination angles of the corresponding inclined surface portions 75 of the front protruded portions 69 relative to the front-rear direction. The rear peripheral surface portions 76 and the corresponding inclined surface portions 75 are set to be parallel to each other. The thickness between each rear peripheral surface portion 76 and the corresponding inclined surface portion 75 is set to be the same as or slightly smaller than the thickness in the front-rear direction of the plate body 61, and be constant along the inclination direction of the rear peripheral surface portion 76 and the inclined surface portions 75.

### Operations of Connector 10

Prior to mating the female connector 11 and the male connector 12 with each other, the lever 18 is held at the mating start position relative to the male housing 15. The lever 18 is prevented from rotating to the mating completion position by the locking action of the initial lock portions 58 on the inner surfaces of the locking recessed portions 51. As shown in FIG. 9, when the lever 18 is at the mating start position, the operation portion 55 is positioned on the front end side of the male connector 12, and the entrances of the cam grooves 57 face the front. The moving plate 17 is disposed at the initial position relative to the male housing 15. As shown in FIG. 4, the plate-side cam pins 65 respectively enter the entrances of the cam grooves 57.

When the moving plate 17 is at the initial position, the front end portions of the tab portions 44 of the male terminal fittings 16 are inserted into the through holes 68 while being guided by the rear peripheral surface portions 76. In the first embodiment, the front end portions of the tab portions 44 are inserted into the through holes 68 along the front-rear direction, and leading end portions of the front end portions protrude forward beyond the front protruded portions 69 (see FIG. 9). In this manner, the front end portions of the tab portions 44 are inserted into not only the through holes 68 in the plate body 61 but also the through holes 68 in the front protruded portions 69 (the straight hole portions 79), and thus, the region of the through holes 68 into which the front end portions of the tab portions 44 are inserted can be made larger than in conventional configurations. For this reason, it is possible to stabilize the state of insertion, including an insertion orientation, of the tab portions 44 into the through holes 68 and maintain the tab portions 44 in a state of being unlikely to deform.

From the above state, the female connector 11 is inserted into the hood portion 38. As shown in FIG. 9, when the female connector 11 reaches a position where the female mating surface 32 of the female housing 13 comes into contact with the front surface of the plate body 61, the front protruded portions 69 are mated with the opening peripheral surface portions 33 of the female housing 13. At this time, the inclined surface portions 75 of the front protruded portions 69 are disposed along the corresponding opening peripheral surface portions 33 of the female housing 13. Specifically, the inclined surface portions 75 of the front protruded portions 69 face the corresponding opening peripheral surface portions 33 of the female housing 13 in a surface contactable manner. The female mating surface 32 of the female housing 13 also faces the front surface of the plate body 61 in a surface contactable manner. Here, the straight hole portions 79 and the tab insertion holes 31 are aligned coaxially in the front-rear direction such that the height positions of the inner surfaces of the straight hole portions 79 and the tab insertion holes 31 are aligned without any difference in level. The leading end portions of the tab portions 44 respectively enter the tab insertion holes 31 of the female housing 13.

When the female connector 11 is inserted into the hood portion 38, the housing-side cam pins 23 and the plate-side cam pins 65 of the moving plate 17 are joined together and inserted into the entrance of the cam grooves 57. In addition, the unlocking portions 24 of the female housing 13 are inserted into the through recessed portions 64 of the moving plate 17 and the locking recessed portions 51 of the hood portion 38. The initial lock portions 58 come into contact with the unlocking portions 24 and are elastically deformed, thereby unlocking the locking recessed portion 51. Accordingly, the lever 18 becomes rotatable toward the mating completion position.

As the lever 18 is rotated toward the mating completion position, the housing-side cam pins 23 and the plate-side cam pins 65, which are in a joined state, move along the groove surfaces of the cam grooves 57. The female connector 11 and the male connector 12 are mated with each other with a low mating force by the cam function of the lever 18. With the rotation of the lever 18, the female connector 11 and the moving plate 17 move toward the male mating surface 46. In this process, the tab portions 44 are disposed in the female cavities 25 from the through holes 68 through the tab insertion holes 31, and are inserted into the connection portions 26 of the female terminal fittings 14 housed in the female cavities 25.

When the lever 18 reaches the mating completion position, the moving plate 17 also reaches the fitting position, and the female connector 11 and the male connector 12 are properly mated to each other. As shown in FIG. 10, when the lever 18 reaches the mating completion position, the operation portion 55 is positioned at the rear end portion of the male connector 12, and the plate-side cam pins 65 and the housing-side cam pins 23 reach the back end side of the cam grooves 57. At this time, the lock arm 59 is locked with the lever lock portion 53, and thereby the lever 18 is held at the mating completion position relative to the male housing 15.

As shown in FIG. 10, when the moving plate 17 is at the fitting position, the plate body 61 is sandwiched between the male mating surface 46 of the male housing 15 and the female mating surface 32 of the female housing 13 in the front-rear direction. The front surface of the plate body 61 comes into surface contact with the female mating surface 32, and the rear surface of the plate body 61 comes into surface contact with the male mating surface 46. The tab portions 44 are deeply inserted into the connection portions 26, and the female terminal fittings 14 and the male terminal fittings 16 are electrically connected in a proper state, respectively. Front portions of the tab portions 44 respectively come into contact with the elastic contact pieces 28 of the connection portions 26. Rear portions of the tab portions 44 are positioned along the front-rear direction in an area extending from the straight hole portions 79 of the through holes 68 to the tab insertion holes 31, respectively.

As described above, the connector 10 according to the first embodiment includes the female connector 11 and the male connector 12 capable of mating with each other. The female connector 11 includes the female housing 13 including the female cavities 25 and the female mating surface 32, and the female terminal fittings 14 that are housed in the female cavities 25. The male connector 12 includes the male housing 15 including the male mating surface 46, the male terminal fittings 16 that are held in the male housing 15, and the moving plate 17 that is disposed movably in the front-rear direction relative to the male housing 15. The male housing 15 includes the tubular hood portion 38 that is open to the front. The male mating surface 46 is configured as a back surface of the hood portion 38. The moving plate 17 includes the plate body 61 whose plate surfaces face the front-rear direction within the hood portion 38, the front protruded portions 69 protruding from the front surface of the plate body 61 that faces the female mating surface 32, out of the plate surfaces of the plate body 61, and through holes 68 that extend through the moving plate 17 from the plate body 61 to the front protruded portions 69.

In the mating process of the female connector 11 and the male connector 12, the plate body 61 is movable rearward, that is, in a direction approaching the male mating surface 46, from the initial position to the fitting position within the hood portion 38, and, when the mating is complete, the plate body 61 is sandwiched between the female mating surface 32 and the male mating surface 46. The male terminal fittings 16 include the tab portions 44 that are inserted into the through holes 68, and are connected to the female terminal fittings 14 when the mating is complete, respectively. The female housing 13 includes the opening peripheral surface portions 33 expanding toward the front protruded portions 69, at the opening edge portions of the female cavities 25 in the female mating surface 32. The front protruded portions 69 have a shape surrounding the entire periphery of the respective through holes 68 on the front surface side of the plate body 61. The outer surface of each front protruded portion 69 includes inclined surface portions 75 that taper toward the front and are disposed along the corresponding opening peripheral surface portions 33 when the mating is complete.

With the above configuration, by inserting the tab portions 44 into the through holes 68, the tab portions 44 are protected not only by the plate body 61 but also by the front protruded portions 69, and thus it is possible to make it unlikely for the tab portions 44 to deform. When the mating of the female connector 11 and the male connector 12 is complete, the inclined surface portions 75 of the front protruded portions 69 are disposed along the corresponding opening peripheral surface portions 33 of the female housing 13. The opening peripheral surface portions 33 of the female housing 13 are an existing configuration provided in the female housing 13 as guides for guiding the tab portions 44 into the female cavities 25. Therefore, it is not necessary to change the shape of the female housing 13 in accordance with the shape of the moving plate 17, nor to change the mold for forming the female housing 13. As a result, cost can be suppressed to be low.

Particularly, since the through holes 68 include the straight hole portions 79 extending linearly in the front-rear direction from the front protruded portions 69, respectively, to the plate body 61, the insertion state of the tab portions 44 can be stabilized, and it is possible to make it further unlikely for the tab portions 44 to deform.

In addition, in the first embodiment, each female cavity 25 includes the tab insertion hole 31 extending in the front-rear direction and facing the corresponding opening peripheral surface portions 33, and the tab insertion hole 31 and the through hole 68 are coaxially continuous in the front-rear direction such that there is no difference in level between the inner surfaces of the tab insertion hole 31 and the through hole 68 when the mating is complete. It is possible to maintain a state where the tab portion 44 is disposed linearly in the front-rear direction in a region extending from the through hole 68 to the tab insertion hole 31 when the mating is complete, and thus the insertion state of the tab portions 44 can be further stabilized.

In addition, in the first embodiment, the plate body 61 has a shape that is longer in the left-right direction than in the up-down direction. A plurality of through holes 68 are aligned vertically and laterally in front view and rear view of the plate body 61. Additionally, a plurality of front protruded portions 69 are provided in correspondence with the respective through holes 68 aligned in the left-right direction in vertical intermediate portions of the plate body 61, and thus, it is possible to avoid a situation where a lateral intermediate portion of the plate body 61 is warped and deformed, for example, in a high-temperature environment.

Furthermore, in the first embodiment, the moving plate 17 includes the rear peripheral surface portions 76 expanding toward the rear surface of the plate body 61, at the rear end opening edge portions of each through hole 68. The inclined surface portions 75 of the front protruded portion 69 and the corresponding rear peripheral surface portions 76 are set to be parallel to each other. For this reason, the thickness formed between the inclined surface portions 75 of the front protruded portion 69 and the respective rear peripheral surface portions 76 of the plate body 61 can be made uniform in the inclination direction of the inclined surface portions 75, thus providing excellent moldability and making it possible to prevent an excessive stress from being generated in the inclined surface portions 75 and the rear peripheral surface portions 76.

### Other Embodiments of Present Disclosure

The embodiment disclosed herein is an example in all respects and should not be interpreted as limiting in any manner.

In the first embodiment above, the female housing 13 is configured to be separable into the female frame 19 and the female inner housing 21. In contrast, according to another embodiment, the female housing may have an integral and non-separable housing structure.

In the first embodiment above, the male housing 15 is configured to be separable into the male frame 35 and the male inner housing 36. In contrast, according to another embodiment, the male housing may have an integral and non-separable housing structure, and be constituted by a housing body including male cavities and a hood portion that protrudes from the housing body.

In the first embodiment above, the plurality of front protruded portions 69 are provided on the front surface side of the plate body 61 in correspondence with all of the through holes 68. In contrast, according to another embodiment, a plurality of front protruded portions may be provided only in correspondence with through holes that are aligned in the left-right direction at vertical intermediate portions on the front surface side of the plate body.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a female connector and a male connector capable of mating with each other,
wherein the female connector includes: a female housing including a female cavity and a female mating surface; and a female terminal fitting that is housed in the female cavity,
the male connector includes a male housing including a male mating surface, a male terminal fitting that is held in the male housing, and a moving plate that is disposed movably in a front-rear direction relative to the male housing,
the male housing includes a tubular hood portion that is open to the front,
the male mating surface is a back surface of the hood portion,
the moving plate includes a plate body whose plate surfaces face the front-rear direction within the hood portion, a front protruded portion that protrudes from a front surface that faces the female mating surface, out of the plate surfaces of the plate body, and a through hole extending through the plate body and the front protruded portion,
the plate body moves rearward, that is, in a direction approaching the male mating surface, from an initial position to a fitting position within the hood portion in a mating process of the female connector and the male connector, and is sandwiched between the female mating surface and the male mating surface when mating is complete,
the male terminal fitting includes a tab portion that is inserted into the through hole, and is connected to the female terminal fitting when the mating is complete,
the female housing includes opening peripheral surface portions expanding toward the front protruded portion, at an opening edge portion of the female cavity in the female mating surface,
the front protruded portion has a shape surrounding an entire periphery of the through hole, on a front surface side of the plate body, and
an outer surface of the front protruded portion includes inclined surface portions that taper toward the front and are disposed along the respective opening peripheral surface portions when the mating is complete.

2. The connector according to claim 1,
wherein the through hole includes a straight hole portion extending in the front-rear direction from the front protruded portion to the plate body.

3. The connector according to claim 2,
wherein the female cavity includes a tab insertion hole extending in the front-rear direction and facing the opening peripheral surface portions, and
the tab insertion hole and the through hole are aligned in the front-rear direction such that there is no difference in level between inner surfaces of the tab insertion hole and the through hole when the mating is complete.

4. The connector according to claim 1,
wherein the plate body has a shape that is longer in a left-right direction than in an up-down direction, a plurality of the through holes are aligned vertically and laterally in front view and rear view of the plate body, and front protruded portions are provided in correspondence with at least through holes aligned in the left-right direction in a vertical intermediate portion of the plate body, from among the plurality of through holes.

5. The connector according to claim 1,
wherein the moving plate includes rear peripheral surface portions expanding toward a rear surface of the plate body, at a rear end opening edge portion of the through hole, and
the inclined surface portions of the front protruded portion and the respective rear peripheral surface portions are set to be parallel to each other.
